(19) United States
(12) Patent Application Publication
(10) Pub. No.: US 2003/0197074 A1
(43) Pub. Date: Oct. 23, 2003

(54) Spray nozzle attachment

(76) Inventors: Gerald J. McNerney, Carmel, IN (US); Jonathan Crowe, Indianapolis, IN (US)

Correspondence Address: Kwadjo Adusei-Poku, Masco Corporation, 21001 Van Born Road, Taylor, MI, 48180, US

(21) Appl. No.: 10/124,652

(22) Filed: Apr. 17, 2002

(51) Int. Cl. B05B 1/32

(52) U.S. Cl. 239/541

(57) ABSTRACT

A body spray and nozzle attachment assembly comprising a body spray having a bulbous body and a neck portion, a nozzle attachment attached to the neck portion of the body spray, and a central fluid passageway passing through the body of the body spray and the cylindrical body of the nozzle attachment. The nozzle attachment has a cylindrical body and a central passageway passing through the nozzle attachment. The nozzle attachment may be placed in either a first extended position along the neck portion of the body spray or in a second retracted position by being moved downwards along the neck portion of the body spray. When in the first extended position, the nozzle attachment causes the fluid to exit the body spray in a first narrow spray pattern, and when the nozzle attachment is placed in the second retracted position, the fluid exits the body spray in a second spray pattern, the second spray pattern being wider than the first spray pattern. The nozzle attachment may be adjusted for any spray pattern between the first narrow pattern and the second wider pattern.

### FIELD OF THE INVENTION

This invention relates to an attachment for a body spray nozzle that adjusts the spray pattern.

### BACKGROUND OF THE INVENTION

Current body spray nozzles have a fixed spray pattern as determined by the design and construction of the spray nozzle. However, although the manufacturer attempts to determine the optimal spray pattern, this is often difficult and ultimately depends upon the user's preferences. Unlike the spray pattern emanating from showerhead attachments, that have long been adjustable by the user, body spray nozzles may only be pivoted about the nozzle sockets without affecting the spray pattern itself.

One commonly sold body spray nozzle has a wide, conical shaped spray pattern that is preferred for the greatest distribution of water from the body spray to the entire body of the individual using the shower. However, this wide conical pattern presents two potential problems. First, the spray may spread such that it is no longer contained within the walls of the shower stall. This may cause the water to be sprayed upon the ceiling, over the shower door or onto regular, unprotected walls. Second, the spray pattern may spread to such an extent as to be too wide to effectively douse the bather. This situation reduces the user's satisfaction with the body spray device.

The present invention solves these problems by providing a way in which the user may adjust the width of the conical pattern while using the body spray nozzles in a shower.

### SUMMARY OF THE INVENTION

The instant body spray nozzle attachment is either inserted on or attached to the body spray nozzle such that the conical spray pattern is modified as the water impacts the extended inner surface of the attachment. In a preferred embodiment, the attachment slides over the nozzle body such that an inner tubular column fits within an annular furrow within the nozzle body. This inner tubular column defines the level at which the water impinges upon the attachment, and thus defines the resulting water pattern from the spray nozzle. Alternatively, the body spray attachment may be threadedly attached to the nozzle body.

### BRIEF DESCRIPTION OF THE DRAWINGS

FIG. 1 is a front elevational view of a body spray nozzle, showing the wide conical spray pattern;

FIG. 2 is an exploded cross-sectional view of the body spray nozzle and the twizzler insert that causes the conical spray pattern;

FIG. 3 is a cross-sectional view of the body spray nozzle having the twizzler insert placed within the body spray body, and further showing the externally-threaded outer surface of the neck of the body spray;

FIG. 4 is an elevational view of the nozzle attachment of the instant invention;

FIG. 5 is a cross-sectional view of the nozzle attachment;

FIG. 6 is an elevational view of the body spray nozzle having the nozzle attachment fitted thereon;

FIG. 7 is a cross-sectional view taken along the lines 7-7 of FIG. 6 showing the nozzle attachment in the fully inserted position, and the resulting spray pattern;

FIG. 8 is an elevational view of the body spray nozzle having the attachment fitted thereon, the attachment positioned in the extended position;

FIG. 9 is a cross-sectional view taken along the lines 9-9 of FIG. 8 showing the nozzle attachment in the extended position, and the resulting spray pattern;

FIG. 10 is a cross-sectional view of an alternative embodiment of the nozzle attachment attached to the body spray nozzle, in the fully inserted position;

FIG. 11 is a cross-sectional view of the alternative embodiment of the nozzle attachment attached to the body spray nozzle, in the fully extended position;

FIG. 12 is an exploded view of another embodiment of the nozzle attachment illustrating an attachment ring to facilitate attaching the nozzle attachment to the body spray nozzle;

FIG. 13 is a cross-sectional view of the embodiment illustrated in FIG. 12, illustrating the threaded attachment of the nozzle attachment to the body spray nozzle; and

FIG. 14 is a cross-sectional view of another embodiment of the invention having the nozzle attachment permanently molded to the body spray nozzle.

### DESCRIPTION OF THE PREFERRED EMBODIMENT

In accordance with the instant invention a body spray nozzle is fitted with an adapter that alters the spray pattern of the body spray. Thus, the nozzle adapter enhances the spray pattern by modifying the wider pattern to one that is narrower in diameter.

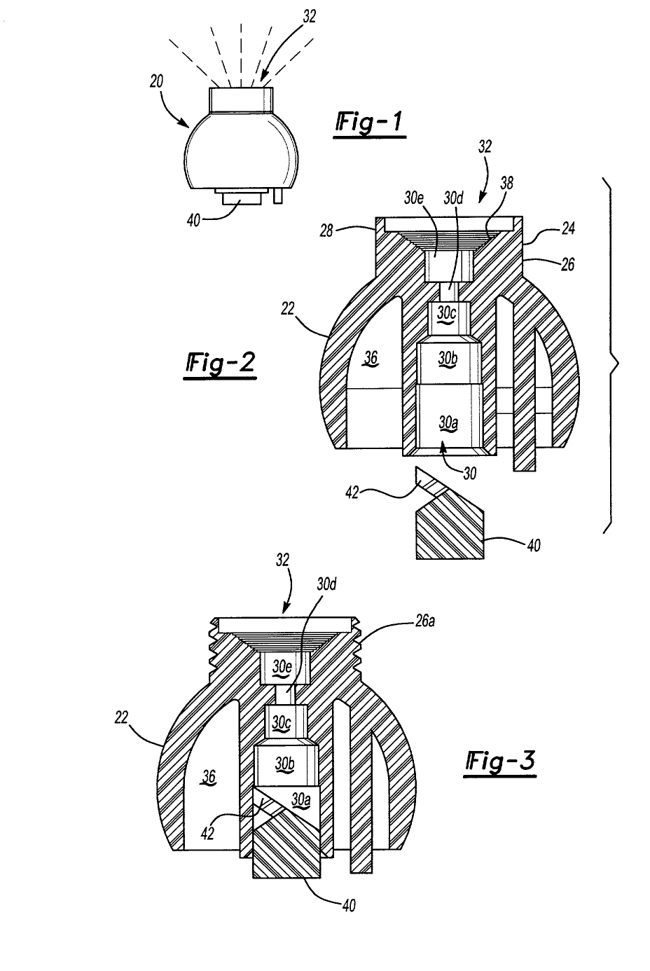

FIGS. 1 and 2 illustrate the body spray nozzle 20 used in one application as part of a shower ensemble, where the body sprays project outwards along the wall of the shower console to direct a stream of water towards a person using the shower. These body sprays may operate independently of or in conjunction with an overhead or elevated showerhead. As shown in FIGS. 1 and 2, the body spray nozzle comprises a nozzle body 22 and a neck portion 24. A fluid passageway 30 traverses the nozzle body and opens to a nozzle orifice 32 at the top of the neck portion 24. The nozzle body 22 contains numerous cavities 36 that are primarily a function of the body construction. These cavities 36 serve to lighten the overall body spray nozzle and are shaped so as to facilitate the molding process.

The fluid passageway 30 comprises a series of constricting sections 30a, 30b, 30c and 30d. These reduced diameter sections serve to accelerate the water through the nozzle body to create a jet spray effect. Fluid passageway section 30e is of larger diameter than section 30d as the fluid passageway begins to open into the wider orifice 32 of the neck portion 24.

The neck portion 24 comprises an outer surface 26 and an inner surface 38. Further, the neck portion 24 culminates at its top region into an annular lip 28 with a top surface 29 surrounding the orifice 32. The inner surface 38 of neck portion 24 is angled inwards towards the perimeter of fluid passageway section 30e. This inner surface 38 may be ridged or scalloped, primarily for decorative purposes.

A twizzler insert 40 in inserted into fluid passageway section 30a. The twizzler insert 40 is substantially hollow and serves to rotate the fluid as it passes through the passageway 30, thereby creating a conical spray pattern. In this embodiment, the twizzler insert 40 comprises a cylindrical base and dual serpentine ramps 42 coiling upwards therefrom.

FIG. 3 illustrates the body spray nozzle 20 in which the outer surface 26a of the neck portion 24 is modified to threadedly receive an attachment according to the instant invention. FIG. 3 further illustrates the twizzler insert 40 inserted within the fluid passageway 30.

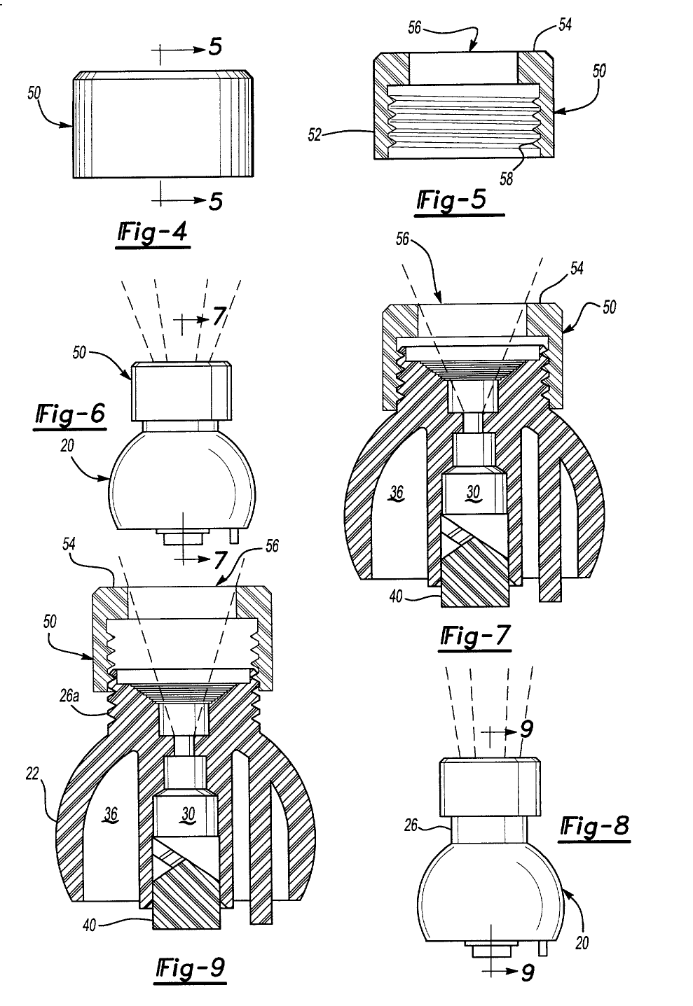

Referring to FIGS. 4 and 5, the nozzle attachment 50 comprises an annular attachment body 52 and an annular attachment ledge 54 on top of the attachment body 52, and surrounding an attachment orifice 56. The inner surface 58 of the attachment body 52 may be threaded, as shown in FIG. 5, for the threaded attachment to the neck 26a of body spray nozzle 20.

FIGS. 6 and 7 illustrate the nozzle attachment 50 threadedly attached to the body spray nozzle 20. As shown, the nozzle attachment 50 is in the fully inserted position. The water or other fluid proceeds via passageway 30 having been shaped as the water passes through and around twizzler 40. The width of the water spray pattern is now determined by the size of the attachment aperture 56 defined by the position of the attachment ledge 54. The spray pattern is narrower than the spray pattern resulting from the body spray without the attachment, as shown in FIG. 1.

FIGS. 8 and 9 illustrate the nozzle attachment 50 threadedly attached to the body spray nozzle 20, but this time positioned in the fully extended position. The width of the water spray pattern is once again determined by the size of the attachment aperture 56 defined by the position of the attachment ledge 54. However, because the attachment is further displaced axially along the neck 26a of the body spray nozzle 20, the spray pattern is narrower than the spray pattern resulting from the body spray with the attachment 50 in the fully inserted position, as shown in FIG. 7. As described, the user is able to adjust the spray pattern from the body spray nozzle 20, by adjusting the axial distance of the attachment 50 along the neck 26, 26a. Although the invention has so far been described as comprising a threaded neck 26a, the attachment 50 may be attached along the neck 26 via other means, for example, a friction fit, as implied in FIG. 8, to allow adjustment of the attachment along the neck. One such embodiment is described below.

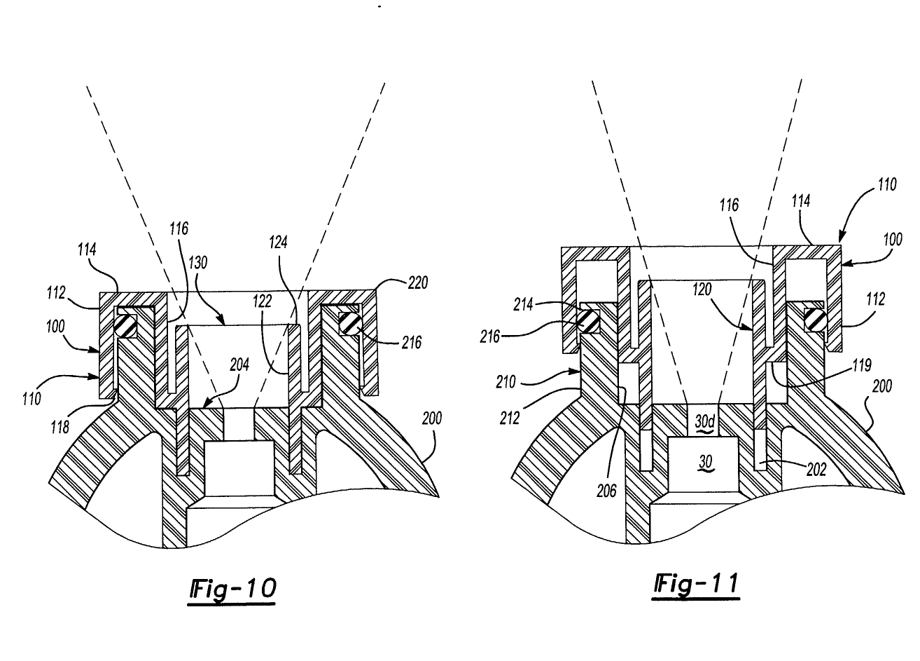

Referring now to FIGS. 10 and 11, an alternative embodiment of the attachment is provided. The alternative attachment 100 comprises an annular collar 110 supporting an annular column 120. The annular collar 110 comprises an outer wall 112, a top portion 114 and an inner wall 116. An inwardly pointing annular ramp 118 is located at the base of the outer wall 112 of the annular collar 110. A bridge 119 at the base of the inner wall 116 attaches the annular collar 110 to the annular column 120. The annular column 120 comprises an inner column wall 122 and a top portion 124. The inner column wall 122 defines an outlet aperture 130 through which the water sprays from the body nozzle 200.

In this embodiment, the neck 210 of the body nozzle 200 has been modified to properly receive the attachment 100. The neck 210 comprises an outer surface 212, into which an annular groove 214 is placed. The annular groove 214 is located towards top end of the neck 210. Also, an annular furrow 202 has been situated in the body of body spray nozzle 200 around the water passageway 30, as best shown in FIG. 11. An O-ring 216 is also provided.

As shown in FIGS. 10 and 11, the attachment 100 is inserted over the neck 210 of the body spray nozzle 200. The annular furrow 202 receives the annular column 120. The O-ring 216 provides an interference fit between the attachment 100 and the body spray nozzle 200. When in use, a bather may adjust the attachment 100 by moving the attachment 100 up the neck 210 of the body spray nozzle 200. The upward travel of attachment 100 is limited when the annular ramp 118 abuts the O-ring 216. This gives the operator a tactile indication that any further upward travel may serve to remove the attachment 100 from the body spray nozzle 200. The attachment 100 may then be reinserted within the body spray nozzle 200 by pushing past the resistance caused by the annular ramp 118 and the O-ring 216. Preferably the attachment is constructed from an elastomeric material, allowing the outer wall 112 to flex outwards as the attachment 100 is reinserted.

As shown in FIG. 10, the width of the spray pattern is now determined by the height between the top portion 124 of the annular column 120 and the surface 204 corresponding to the top of the water passageway section 30d of water passageway 30. As the attachment 100 is extended outwards from the body spray nozzle 200, the height between the top portion 124 and the surface 204 increases, thereby reducing the width of the resulting spray pattern.

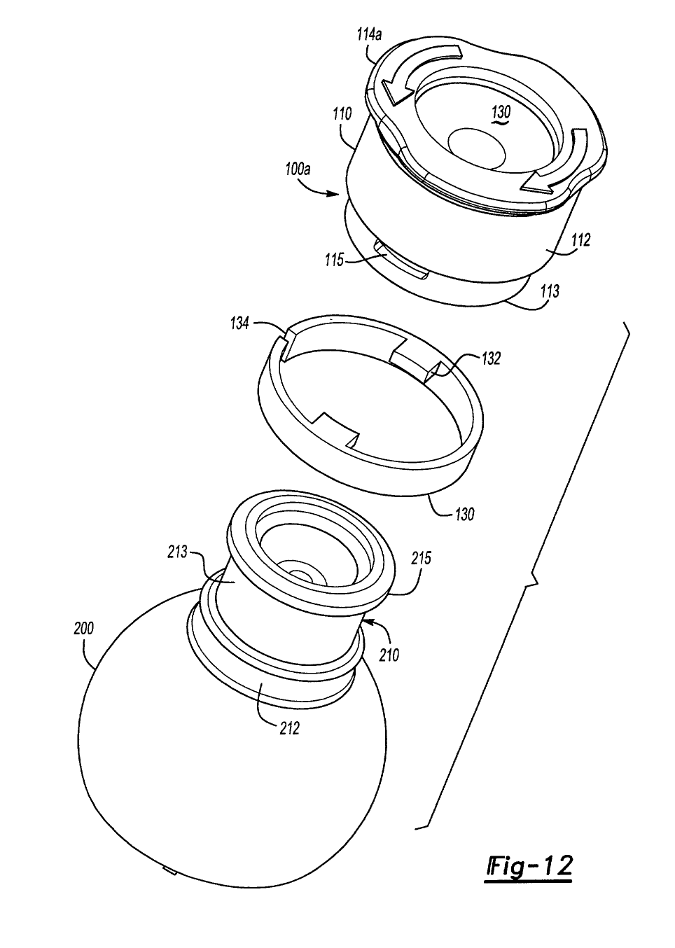

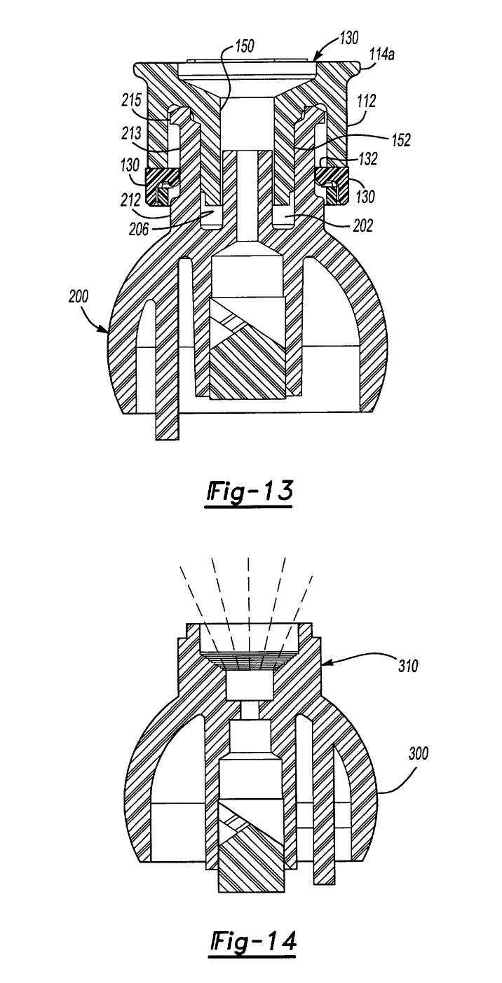

FIGS. 12 and 13 illustrate a modification to the alternate embodiment for the attachment 100. As illustrated in FIG. 12, a split attachment ring 130 is provided as an alternative means for attaching and securing the attachment 100 to the body spray 200. The modified attachment 100a comprises an outer wall 112 having a narrower base portion 113. A plurality of slots 115 are placed through this base portion 113. Although two opposing slots 115 are shown, one slot would be sufficient and more slots may also be employed. Another feature of attachment 100a is the top portion 114a that extends outwards and is contoured to provide an additional gripping surface for a user as the attachment is rotated between the retracted and extended positions.

The split attachment ring 130 has an opening 134 that allows the attachment ring 130 to slip over the base portion 113 of annular collar 110. A plurality of tabs 132 are provided along the inner surface of the attachment ring 130. These tabs snap into the slots 115 in the base portion 113, and protrude through the annular collar 110. The split attachment ring 130 is preferably made from a resilient plastic material to allow it to return to its original shape after is has been placed around the base portion 113 of attachment 100a.

With this modification to the attachment 100a, the neck 210 of the body spray nozzle 200 is also modified as shown in FIG. 12. The neck 210 contains a narrower waist portion 213 and an outwardly extending lip 215 along the top of the neck 210. In assembly, the attachment 100a is placed over the body spray nozzle 200 and the split attachment ring 130 is snapped into place with its tabs 132 extending inwards through slots 115. In this configuration, the tabs 132 rest within the narrow waist portion 213 and ride between the outer surface 212 and the outwardly extending lip 215.

As shown in FIG. 13, it is also envisioned that the annular column 120 is merged into the inner wall 116 to form an integral inner annular column 150. This adaptation provides certain advantages in the manufacturing of attachment 100a.

In order to provide a more exact method for adjusting the location of the attachment 100a along the neck 210 of the body spray nozzle 200, the outer surface 152 of inner annular column 150 is threaded. Corresponding threads are placed upon the inner surface 206 of neck 210 of body spray nozzle 200. The threads allow a person using the body spray to finely adjust the adapter 100a to a desired location along the neck 210 by screwing the adapter 100a into position. When the adapter 100a reaches its fully extended position, the tab 132 abuts against the outwardly extending annular lip 215 and prevents further upward travel of the attachment 100a.

FIG. 14 illustrates yet another embodiment of the invention where the body spray nozzle 300. In this embodiment, the body spray nozzle 300 is constructed having the attachment molded as an integral part of the neck 310. In this embodiment, the width of the spray pattern is fixed and may not be adjusted by the user.

While the invention has been described in what is considered to be a preferred embodiment, other variations and modifications will become apparent to those skilled in the art. It is intended, therefore, that the invention not be limited to the illustrative embodiment but be interpreted within the full spirit and scope of the appended claims.

What is claimed is:

1. A body spray and nozzle attachment assembly comprising:
a body spray having a bulbous body and a neck portion;
a nozzle attachment extendably attached to the neck portion of the body spray, the nozzle attachment having a cylindrical body and a central passageway passing through the nozzle attachment, the cylindrical body having an outer surface, an inner surface and a top portion;
a central fluid passageway passing through the body of the body spray and the cylindrical body of the nozzle attachment, the fluid passageway allowing fluid to pass through the body spray and the nozzle attachment, wherein the nozzle attachment may be placed in a first extended position by being extend upwards along the neck portion, and then be placed in a second retracted position by being moved downwards along the neck portion of the body spray, such that, when in the first extended position, the nozzle attachment causes the fluid to exit the body spray in a first spray pattern, and when the nozzle attachment is placed in the second retracted position, the fluid exits the body spray in a second spray pattern, the second spray pattern being wider than the first spray pattern.

2. The body spray and nozzle attachment assembly according to claim 1, wherein the nozzle attachment may be positioned at an intermediary position between the first extended position and the second retracted position along the neck portion of the body spray, thereby achieving a spray pattern that is between the first spray pattern and the second wider spray pattern.

3. The body spray and nozzle attachment assembly according to claim 2, further comprising:
external threads along the neck portion of the body spray;
mating threads along the inner surface of the nozzle attachment, such that the mating threads of the nozzle attachment engage the external threads along the neck portion of the body spray, resulting in the threaded attachment of the nozzle attachment to the body spray.

4. The body spray and nozzle attachment assembly according to claim 3, wherein the top portion of the nozzle attachment extends inwards to form an annular ring around a central aperture, the central aperture being in fluid communication with the central fluid passageway.

5. A body spray and nozzle attachment assembly comprising:
a body spray having a bulbous body portion and a neck portion, the neck portion having an inner surface, a top surface and an outer surface;
a nozzle attachment fitted around the neck portion of the body spray, and anchored to the body portion of the body spray, the nozzle attachment having an inner cylindrical shaft, an inner cylindrical wall attached to the inner cylindrical shaft by a bridge, an outer cylindrical wall attached to the inner cylindrical wall by a top ledge portion, and a central passageway passing through the inner cylindrical shaft of the nozzle attachment;
a central fluid passageway passing through the body of the body spray and being in fluid communication with the central passageway of the nozzle attachment, the fluid passageway allowing fluid to pass through the body spray and the nozzle attachment, wherein the nozzle attachment may be placed in a first extended position by being extend upwards along the neck portion, and then be placed in a second retracted position by being moved downwards along the neck portion of the body spray, such that, when in the first extended position, the nozzle attachment causes the fluid to exit the body spray in a first spray pattern, and when the nozzle attachment is placed in the second retracted position, the fluid exits the body spray in a second spray pattern, the second spray pattern being wider than the first spray pattern.

6. The body spray and nozzle attachment assembly according to claim 5, wherein the nozzle attachment may be positioned at an intermediary position between the first extended position and the second retracted position along the neck portion of the body spray, thereby achieving a spray pattern that is between the first spray pattern and the second wider spray pattern.

7. The body spray and nozzle attachment assembly according to claim 6, wherein
the inner cylindrical shaft comprises a top portion above the bridge and a bottom portion below the bridge attaching the inner cylindrical shaft to the inner cylindrical wall; and wherein
the inner cylindrical wall extends above the inner cylindrical shaft; and wherein
the outer cylindrical wall has a top portion adjoining the top ledge portion, and a bottom portion; and wherein
the body portion of the body spray has a top flat surface extending radially inwards from the neck portion and surrounding the central fluid passageway.

8. The body spray and nozzle attachment assembly according to claim 7, further comprising an annular trench burrowed into the top flat surface of the body portion of the body spray, the annular trench surrounding the central fluid passageway, such that as the nozzle attachment is secured to the body spray, the bottom portion of the inner cylindrical shaft fits securely within the annular trench and the neck portion of the body spray fits between the inner cylindrical wall and the outer cylindrical wall of the nozzle attachment.

9. The body spray and nozzle attachment assembly according to claim 8, further comprising:
an annular groove around the neck portion of the body spray;
an o-ring inserted within the annular groove around the neck portion of the body spray, thereby forming a fluid seal between the nozzle attachment and the body spray.

10. The body spray and nozzle attachment assembly according to claim 9, further comprising an annular ramp extending inwards from the bottom portion of the outer cylindrical wall towards of the inner cylindrical wall of the nozzle attachment, such that, as the nozzle attachment is extended upwards along the neck portion of the body spray, the annular ramp abuts the o-ring, thereby signaling the end of upward travel.

11. A nozzle attachment for a body spray comprising:
an inner cylindrical shaft,
an inner cylindrical wall attached to the inner cylindrical shaft by a bridge,
an outer cylindrical wall attached to the inner cylindrical wall by a top ledge portion, and
a central passageway passing through the inner cylindrical shaft of the nozzle attachment;
such that, when attached to the body spray having a neck portion, the nozzle attachment may be placed in a first extended position by being extend upwards along the neck portion of the body spray, and then be placed in a second retracted position by being moved downwards along the neck portion of the body spray, such that, when in the first extended position, the nozzle attachment causes the fluid to exit the body spray in a first spray pattern, and when the nozzle attachment is placed in the second retracted position, the fluid exits the body spray in a second spray pattern, the second spray pattern being wider than the first spray pattern, and where the nozzle attachment may be positioned in any intermediate position along the neck portion between the first extended position and the second retracted position.

12. The nozzle attachment for a body spray according to claim 11, wherein
the inner cylindrical shaft comprises a top portion above the bridge and a bottom portion below the bridge attaching the inner cylindrical shaft to the inner cylindrical wall; and wherein
the inner cylindrical wall extends above the inner cylindrical shaft; and wherein
the outer cylindrical wall has a top portion adjoining the top ledge portion, and a bottom portion.

13. The nozzle attachment for a body spray according to claim 12, further comprising an annular ramp extending inwards from the bottom portion of the outer cylindrical wall towards of the inner cylindrical wall of the nozzle attachment, such that, as the nozzle attachment is extended upwards along the neck portion of the body spray, the annular ramp abuts an o-ring affixed to the neck portion of the body spray, thereby signaling the end of upward travel of the nozzle attachment.

14. A body spray and nozzle attachment assembly comprising:
a body spray having a body portion and a neck portion, the neck portion having an inner surface, a top section and an outer wall;
a nozzle attachment fitted around the neck portion of the body spray, the nozzle attachment having an inner shaft, an outer wall portion separated from the inner shaft, and a bridge portion connecting the inner shaft surrounding a central passageway passing through the nozzle attachment;
a split attachment ring for securing the nozzle attachment to the body spray, and
a central fluid passageway passing through the body of the body spray and being in fluid communication with the central passageway of the nozzle attachment, the fluid passageway allowing fluid to pass through the body spray and the nozzle attachment,
wherein the nozzle attachment may be placed in a first extended position by being extend upwards along the neck portion, and then be placed in a second retracted position by being moved downwards along the neck portion of the body spray, such that, when in the first extended position, the nozzle attachment causes the fluid to exit the body spray in a first spray pattern, and when the nozzle attachment is placed in the second retracted position, the fluid exits the body spray in a second spray pattern, the second spray pattern being wider than the first spray pattern.

15. The body spray and nozzle attachment assembly according to claim 14, wherein the inner surface of the neck portion is threaded, and wherein the inner shaft of the nozzle attachment has an outer surface that is also threaded, such that the nozzle attachment may be threadedly attached to the body spray.

16. The body spray and nozzle attachment assembly according to claim 14, wherein the split attachment ring has an inner surface and contains an opening therein, and further comprising:
a plurality of tabs extending from the inner surface of the split attachment ring towards the center of the ring.

17. The body spray and nozzle attachment assembly according to claim 16, wherein the outer wall portion of the nozzle attachment has a base section, the base section containing a plurality of slots passing there through, and wherein each tab of the attachment ring fits within, and protrudes through, a slot in the outer wall portion.

18. The body spray and nozzle attachment assembly according to claim 17, wherein the top section of the neck portion of the body spray extends outwards to form an annular lip, such that, when the nozzle attachment and the attachment ring are mounted upon the body spray, the tabs of the attachment ring abut against the annular lip of the body spray, thereby preventing the nozzle attachment from sliding off the body spray.
